(19) United States
(12) Patent Application Publication
(10) Pub. No.: US 2020/0377231 A1
(43) Pub. Date: Dec. 3, 2020

(54) Fluid Handling System for Airplane Ground Deicing Equipment

(71) Applicant: Valentin Luca, Santa Barbara, CA (US)

(72) Inventor: Valentin Luca, Santa Barbara, CA (US)

(21) Appl. No.: 16/604,889

(22) PCT Filed: Apr. 12, 2018
(86) PCT No.: PCT/US18/27327

§ 371 Date: Oct. 11, 2019

Related U.S. Application Data
(60) Provisional application No. 62/485,105, filed on Apr. 13, 2017.

(51) Int. Cl. B64F 5/23; B66F 11/04

(52) U.S. Cl. CPC B64F 5/23; B66F 11/044

(57) ABSTRACT

Systems and methods of handling fluids used in ground deicing and anti-icing of airplanes are provided. The disclosed systems/methods are particularly advantageous in delivering non-Newtonian fluids used in anti-icing applications. Maintaining the viscosity of non-Newtonian fluids used in deicing of airplanes within strict limits is of paramount importance for the safe take off/operation of the airplane. The disclosed systems/methods help maintain the viscosity within desired ranges by eliminating two main factors that lead to viscosity deterioration, namely, pumping and high shear stress in piping.

### CROSS-REFERENCE TO RELATED APPLICATION

The present application claims priority benefit to a U.S. provisional patent application entitled “Fluid Handling System for the Airplane Ground Deicing Equipment,” which was filed on Apr. 13, 2017, and assigned Ser. No. 62/485,105. The entire content of the foregoing provisional application is incorporated herein by reference.

### TECHNICAL FIELD

The present invention relates to systems and methods of handling fluids used in ground deicing and anti-icing of airplanes and, in particular, it relates to the handling of non-Newtonian fluids used in anti-icing applications. Maintaining the viscosity of non-Newtonian fluids used in deicing of airplanes within strict limits is of paramount importance for the safe take off/operation of the airplane. The disclosed systems/methods help maintain the viscosity within desired ranges by eliminating two main factors that lead to viscosity deterioration, namely, pumping and high shear stress in piping.

### BACKGROUND OF THE INVENTION

Non-Newtonian fluids are frequently used as anti-icing agents. They prevent snow or ice adherence to the skin of a deiced airplane until the airplane takes off. The non-Newtonian fluids used for airplane ground deicing are generally glycol-based fluids containing thickening additives that give the glycol the non-Newtonian properties.

Of note, for Newtonian fluids, the stress tensor is proportional to the deformation speed while, for a non-Newtonian fluid, the stress tensor depends both on the deformation speed and on the accelerations.

The viscosity of non-Newtonian fluids generally prevents them from flowing off the skin of the airplane, thereby creating a layer that prevents icing contamination from adhering to the airplane's skin. The viscosity is generally controlled such that the non-Newtonian fluid comes off the skin of the airplane only at about the rotation speed of the airplane (i.e., takeoff).

Unfortunately, the viscosity of non-Newtonian fluid is degraded by aggressive pumping and high shear stress in piping.

Some of today's airplanes have 9,000 sq. ft. wing surface and a height of up to 79 ft. and, therefore, ground deicing installations need to be equipped with systems that provide high pressure and high fluid dispersion speed to achieve the desired deicing fluid application to the airplane's skin.

Despite efforts to date, a need remains for effective systems for handling and delivering deicing fluids and anti-icing fluids to airplane surfaces/skins without degrading the viscosity of the fluids, particularly non-Newtonian fluids. These and other needs are addressed by the systems and methods of the present disclosure.

### SUMMARY OF THE INVENTION

The present invention advantageously replaces pump(s) used as part of conventional airplane ground deicing installations for pumping non-Newtonian fluids with a gas pressure displacement system that minimizes any potential rupture of the thickener additive molecules, rupture that disadvantageously causes the alteration of the fluid's viscosity.

Of note, any pump type, regardless of how simple the pump design is, induces shear stress in the fluid. Even diaphragm type pumps induce such stress; not the diaphragm itself, but the associated one-way valves.

Another aspect of the present invention is to reduce the fluid shear stress through selection/implementation of advantageous piping to the discharge nozzles. Current deicing and anti-icing procedures used by both old style deicing trucks as well as the newest high-speed deicing installations (e.g., the deicing systems/methods described in US Patent Publication No. 2015/0298826 to Luca, the entire content of which is incorporated herein by reference) is to first deice the airplane and then to apply non-Newtonian fluid if conditions of re-contaminations exist. Deicing-related delays cost airlines on the order of billions each season and, therefore, deicing and anti-icing must be performed at highest speed that still assures the safety of the takeoff.

However, to increase deicing speed entails high speed flow through the piping and, even if piping is carefully designed to avoid sharp bends and other flow disturbances, the shear stress increases as the fluid velocity increases.

The systems and methods disclosed in the present invention use air-pressurized tanks—instead of pumps—to move the non-Newtonian fluid. In exemplary embodiments, systems of the present invention also employ buffer tanks situated at certain height(s) that are filled at a slow rate to further protect the fluid's viscosity. The non-Newtonian fluid is dispersed at higher rate, as needed, from these tanks by one or several nozzles that may be advantageously shaped/designed to further protect the fluid's viscosity.

The systems disclosed by the present invention may be advantageously applied both to deicing trucks and as well to the newest type of high speed deicing installations as, for example, the systems and methods described in US Patent Publication No. 2015/0298826 to Luca (previously incorporated in its entirety be reference).

Thus, in exemplary embodiments, the present invention discloses buffer tank(s) that is/are located closer to the dispersing nozzles. In implementations that include deicing trucks, the buffer tank(s) may be advantageously placed adjacent to operator cherry-picker nacelle and, in the case of the high speed deicing installations described in US Patent Publication No. 2015/0298826 to Luca, an exemplary location for the buffer tank(s) is on the over wing structure.

The deicing/anti-icing fluid from the buffer tank(s) may be advantageously pumped toward the dispersing nozzles by air pressure according to a first aspect of the disclosed invention.

One advantage of the buffer tank(s) is that the anti-icing, non-Newtonian fluid does not need to be pumped at that height in real time, but it could be filled slowly while the deicing operation takes place.

For deicing truck applications, the non-Newtonian fluid may be pumped through one or a limited number of nozzles and this translates into a relatively high shear stress. On the high speed deicing installation as described in US Patent Publication No. 2015/0298826 to Luca, the fluid may be dispensed through a large number of nozzles at low, practically dripping speeds.

### BRIEF DESCRIPTION OF THE FIGURES

To assist those of skill in the art in making and using the disclosed systems, reference is made to the accompanying figures, wherein:

FIG. 1 is a schematic view of an exemplary system according to the present disclosure;

FIG. 2 is a side view of an exemplary storage tank according to the disclosed system;

FIG. 3 is a further schematic view of a system according to the present disclosure; and

FIG. 4 is a schematic view of a further exemplary tank for use in disclosed implementations of the present disclosure.

### DESCRIPTION OF EXEMPLARY EMBODIMENT(S)

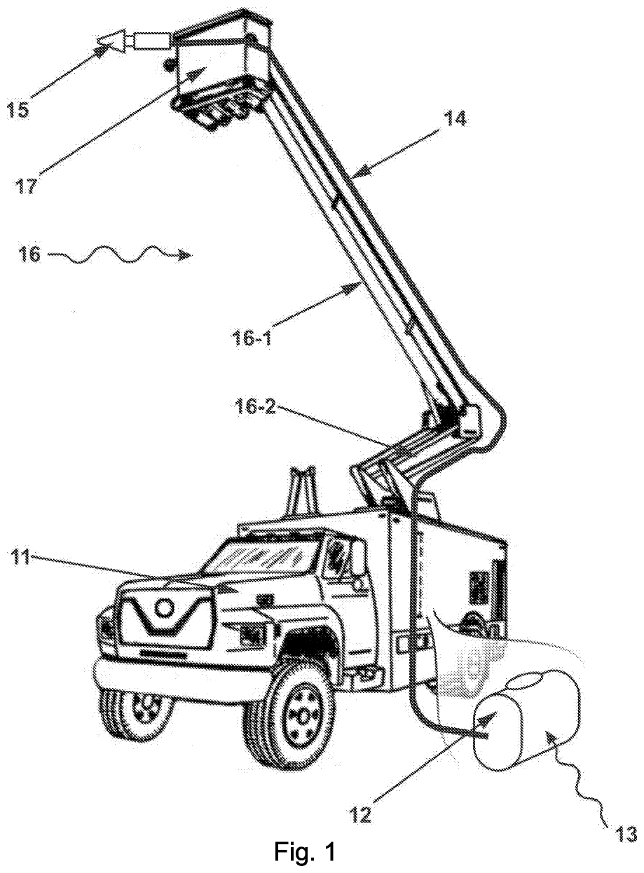

The exemplary deicing truck 11 shown in FIG. 1 is provided with a storage tank 12 for non-Newtonian fluid 13. Tank 12 is advantageously built to withstand a pressure P1, enough to overcome the fluid head, commensurate with the height of the airplanes intended to be deiced, plus the pressure needed to overcome the hydraulic resistance through the piping schematically shown at 14 and provide the required nozzle flow at the nozzle discharge 15. The piping 14 is attached to the beam system 16 that supports the nacelle 17 of the fluid spraying operator.

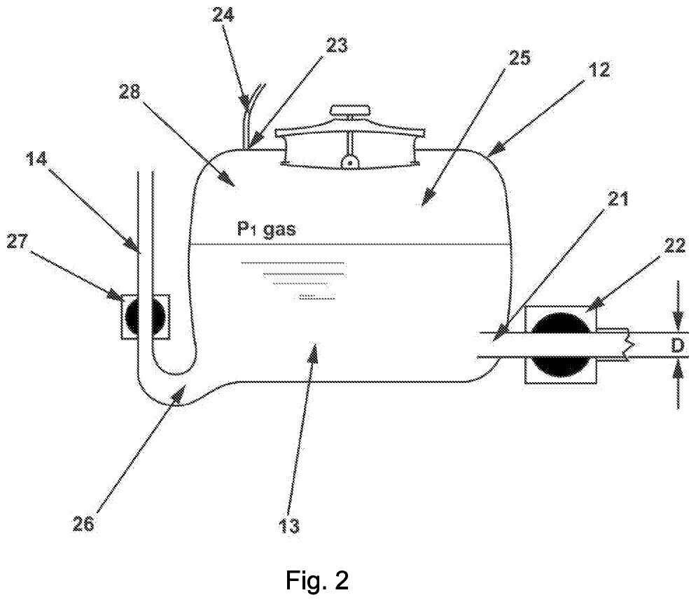

Tank 12 shown in FIG. 2 is provided with a refill inlet 21 provided with a valve 22, that is recommended to be of smooth bore type. Size D of the inlet 21 and the valve 22 is recommended to be large enough to allow the refill of the tank 12 within acceptable time while maintaining a low velocity/shear stress of the fluid. On its upper side, the tank 12 is also provided with an inlet 23 for a pipe 24 that fills the volume 25 of the tanks with compressed gas that, by this pressure, displaces the fluid 13. The gas could be air or nitrogen or other gas that better protects the chemical properties of the non-Newtonian fluid 13.

The compressed gas is generally supplied by a compressor equipped with a pressure regulator, not shown, to regulate pressure at the P1 level. The compressor is generally driven directly by the main engine of the truck 11 (FIG. 1) or through hydraulic or electric motor means, not shown. The tank 12 is provided with an outlet 26, shaped for laminar flow. A smooth bore type valve 27 is also shown that connects the pipe 14 through which the fluid moves towards the discharge nozzle 15 or to a buffer tank. as described herein below.

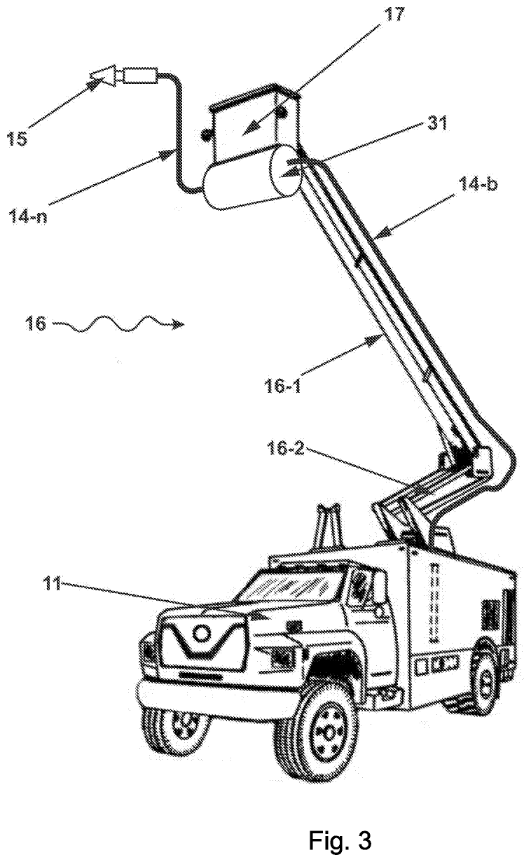

FIG. 3 shows a deicing truck provided with a buffer tank 31 attached by means, not shown, to the beam 16-1 of the beam system 16 that supports the nacelle 17 of the operator, close to the nacelle of the operator or directly attached by means, not shown, to the nacelle of the operator 17.

In the system described in FIG. 1, the non-Newtonian fluid is pushed through the piping 14 only after the airplane was deiced using the deicing fluids.

The buffer tanks 31 shown in FIG. 3 helps to assure that the time used for deicing is usable to fill the buffer tank 31 with anti-icing non-Newtonian fluid through the pipe 14-b. The pipe is labeled 14-b because it discharges into the buffer tank 31 instead of going directly to the discharge nozzle 15, as shown in FIG. 1.

Inclusion of the buffer tanks ensures that the flow rate through the piping 14-b, schematically shown, could be substantially lower than the flow rate needed to pump all the needed Non-Newtonian fluid only after deicing.

Of note, the needed quantity of non-Newtonian fluid is generally approximately 1 quart per 10 sq. ft. of wing area and, taking into account that deicing of a large airplane is performed by 4-6 deicing trucks, and the fact that the time used for dispersing the non-Newtonian fluid is still usable to pump fluid from the tank 12 to tanks 31, the result is that the weight of the filled buffer tank 31 is such that it doesn't require a major redesign of the beam system 16, but may require some strengthening relative to conventional beam assemblies.

The piping, schematically shown 14-n, from the buffer tank 31 to the discharge nozzle 15 is relatively short and this reduces the hydraulic resistance along the piping and hence imparts a less negative effect on the viscosity of the non-Newtonian fluid even when all the needed non-Newtonian fluid is pumped in a short time.

The recommended system to pump the non-Newtonian fluid from the tanks 31 is by compressed gas that is filled in the tanks 31 at a pressure regulated at value P2. Pressure P2 is set as needed for the flow rate of the non-Newtonian fluid. Pressure P1 is set such that it overcomes the pressure P2, the height difference between the storage tank 12 and buffer tank 31 plus the hydraulic resistance for the desired flow rate for filling the buffer tank 31.

The buffer tank 31 is of a construction that allows it to be pressurized to pressure P2 and the only requirement for shape is to allow it to be attached to the beam 16-1 or to the nacelle 17 in a system that minimizes the loads on the beam system 16 and allows the beam system to be folded and allows the piping 14-n to be connected to an outlet that maximizes the usable quantity of the fluid in the tanks 31.

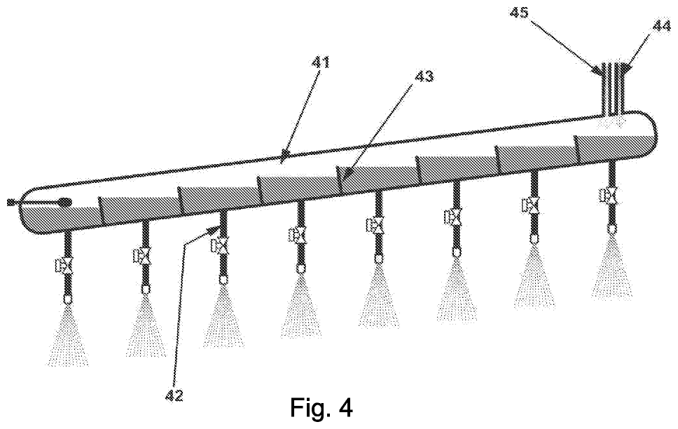

FIG. 4 shows a special shape tank 41 that is designed to be used on a high speed deicing installation as, for instance, that disclosed in US Patent Publication No. 2015/0298826 to Luca. The elongated structure is suitable to disperse the non-Newtonian fluid through a plurality of pipes 42 at low, dripping, speed. The recommended position of the tanks in conjunction with the systems/methods disclosed in US Patent Publication No. 2015/0298826 to Luca is on the over wing contouring structures. The separators 43 are designed to allow the tank 41 to operate at an angle as required by the dihedral angle of the deiced wing. For all practical reasons, the fluid and the pressurizing gas inlets 44 and 45 are placed on the side that normally could reach the highest position

It is to be understood that, based on the information disclosed in the present disclosure, it could be derived many other variations of handling the non-Newtonian fluids on airplane ground deicing equipment using gas pressures applied to a combination of storage and buffer tanks.

For example, smooth bore valves, nozzles and cleaned shape hydrodynamic piping are good practice recommended for all ground deicing types of equipment.

1. A ground deicing system, comprising:
a. at least one storage tanks used to store fluids used for ground deicing and anti-icing of airplanes;
b. a source of pressurized gas in fluid communication with the at least one storage tank;
c. at least one discharge nozzle in fluid communication with the at least one storage tank;
wherein the gas pressure in the at least one storage tank equals or exceeds a pressure value sufficient to push deicing fluid at a desired flow rate to the at least one discharge nozzle positioned at a height for deicing an airplane.

2. A ground deicing system as described in claim 1, further comprising at least one buffer tank positioned s in proximity to the at least one discharge nozzle, and wherein the gas pressure in the at least one storage tank is at a pressure value sufficient to push deicing fluid through one or more pipes at a desired flow rate for discharge to the at least one buffer tank.

3. A ground deicing system as described in claim 2, wherein the at least one buffer tank is provided with at least one outlet in fluid communication with at least one pipe that conducts deicing fluid to the at least one discharge nozzle.

4. A ground deicing system as described in claim 3, wherein the deicing fluid is pushed by gas pressure supplied by the source of pressurized gas from the at least one storage tank to the at least one buffer tank.

5. A ground deicing system as described in claim 4, further comprising pressure regulating means in communication with an inlet to the at least one buffer tank.

6. A ground deicing system as described in claim 5, wherein the pressure inside the at least one buffer tank is regulated to a value effective to achieve a required nozzle velocity.

7. A ground deicing system as described in claim 2, further comprising at least one driven pump, and wherein deicing fluid is pumped from the at least one buffer tank by the at least one driven pump.

8. A ground deicing system as described in claim 7, wherein the pressure in the at least one buffer tanks is at or below atmospheric pressure

9. A ground deicing system, comprising:
a. at least one storage tank used to store fluids used for ground deicing of airplanes, anti-icing of airplanes, or a combination of ground deicing and anti-icing of airplanes;
b. at least one fluid re-fill inlet associated with the at least one storage tank;
c. at least one fluid outlet associated with the at least one storage tank;
d. at least one gas inlet associated with the at least one storage tank for external gas supply;
e. a source of pressurized gas in communication with the at least one gas inlet;
f. at least one buffer tank in fluid communication with the at least one fluid outlet;
g. at least one buffer fluid outlet associated with the at least one buffer tank;
h. at least one discharge nozzle in fluid communication with the at least one buffer fluid outlet;
wherein deicing fluid is pushed by gas pressure supplied by the source of pressurized gas to the at least one buffer tank, and
wherein the gas pressure in the at least one buffer tank is regulated to a pressure value sufficient to achieve a required nozzle velocity at the at least one discharge nozzle.

10. A ground deicing system as described in claim 9, further comprising pressure regulating means in communication with the at least one buffer tank.
